(19) United States
(12) Patent Application Publication
(10) Pub. No.: US 2025/0115272 A1
(43) Pub. Date: Apr. 10, 2025

(54) SYSTEMS AND METHODS FOR PROTECTING A FIRST VEHICLE USING A SECOND VEHICLE

(71) Applicant: Toyota Motor Engineering & Manufacturing North America, Inc., Plano, TX (US)

(72) Inventor: Shaurya Panthri, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/483,753

(22) Filed: Oct. 10, 2023

(51) Int. Cl. B60W 60/00

(52) U.S. Cl. CPC B60W 60/001; B60W 2554/40

(57) ABSTRACT

System, methods, and other embodiments described herein relate to improving the protection of a first vehicle using a second vehicle. In one embodiment, a method includes processing sensor data about surroundings of a first vehicle to identify suspicious activity in the surroundings of the first vehicle. The method further includes, in response to identifying the suspicious activity, controlling a second vehicle to perform a reactive maneuver.

### TECHNICAL FIELD

The subject matter described herein relates, in general, to improving providing protection for a first vehicle in the presence of suspicious activity and, more particularly, to providing protection for a first vehicle in the presence of suspicious activity by controlling a second vehicle to perform reactive maneuvers.

### BACKGROUND

Vehicles are prone to theft and damage from unauthorized users when left unsupervised. For example, vehicles parked in uncovered, open spaces are accessible by unauthorized users. Current methods of providing protection to vehicles from theft include the use of physical barriers, such as locks, and deterrence systems, such as alarms. However, even in the presence of locks and alarms, an unauthorized user can break into a vehicle using force. If the unauthorized user gains access to the vehicle interior and has a clear path out of a parking area, the vehicle can be moved and stolen. As such, current methods do not actually prevent vehicles from being stolen. Rather, the current methods act as a deterrence to criminals.

### SUMMARY

In one embodiment, a system is disclosed. The system includes a processor and a memory communicably coupled to processors. The memory stores instructions that, when executed by the processor, cause the processor to process sensor data about surroundings of a first vehicle to identify suspicious activity in the surroundings of the first vehicle and responsive to identifying the suspicious activity, control a second vehicle to perform a reactive maneuver.

In another embodiment, a non-transitory computer-readable medium includes instructions that, when executed by a processor, cause the processor to process sensor data about surroundings of a first vehicle to identify suspicious activity in the surroundings of the first vehicle and responsive to identifying the suspicious activity, control a second vehicle to perform a reactive maneuver.

In yet another embodiment, a method is disclosed that includes processing sensor data about surroundings of a first vehicle to identify suspicious activity in the surroundings of the first vehicle. The method further includes, in response to identifying the suspicious activity, controlling a second vehicle to perform a reactive maneuver.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a lead vehicle and a following vehicle connected in a hitchless towing configuration.

FIG. 2 illustrates one embodiment of a vehicle within which systems and methods disclosed herein may be implemented.

FIG. 3 illustrates one embodiment of a guardian system that is associated with controlling a second vehicle to execute a reactive maneuver.

FIG. 4 illustrates one embodiment of a method that is associated with controlling a second vehicle to execute a reactive maneuver in response to identifying suspicious behavior in the surroundings of a first vehicle.

FIG. 5 illustrates a sequence associated with a second vehicle restricting movement of a first vehicle.

FIG. 6 illustrates a sequence associated with a second vehicle restricting access to a door of a first vehicle.

FIG. 7 illustrates a sequence associated with a second vehicle restricting following a suspicious party in the surroundings of a first vehicle.

FIG. 8 illustrates a sequence associated with a second vehicle blocking the view of a first vehicle to a party in the surroundings of the first vehicle.

### DETAILED DESCRIPTION

Systems, methods, and other embodiments associated with improving the protection of a first vehicle using a second vehicle are disclosed herein. As previously discussed, when vehicles are left unsupervised and accessible by unauthorized users, the vehicles can be broken into, stolen, and/or damaged. Current methods to prevent vehicle theft include providing vehicle owners with theft deterrence measures, such as locks and alarms. However, current methods do not prevent vehicles from being stolen once an unauthorized user has gained access to the interior of the vehicle.

Therefore, in one embodiment, a system that improves providing protection for a first vehicle by controlling a second vehicle is disclosed. In one aspect, the first vehicle and the second vehicle are vehicles that are wirelessly connected to one another, such as in a hitchless towing configuration, such as described in U.S. Pat. App. Pub. No 2023/0236593, which is hereby incorporated by reference in its entirety. As such, in one embodiment, the second vehicle is configured to autonomously follow the first vehicle. The second vehicle can be controlled to follow the first vehicle by receiving instructions from the first vehicle, by following the first vehicle using sensors, by processing sensor data captured by the first vehicle to determine appropriate maneuvers to execute, or by any other suitable method. In one arrangement, the first and second vehicles are further configured to share sensor data with one another via a wireless connection. As such, the system, in one configuration, acquires sensor data about surroundings of the first vehicle. In one embodiment, the sensor data is acquired from the first vehicle, the second vehicle, or a combination of the two vehicles. The system may further control the second vehicle to maneuver to a position that is optimal for viewing the first vehicle. In this way, the system ensures that the sensors of the second vehicle properly monitor the first vehicle.

In one approach, the system processes the sensor data to identify suspicious activity in the surroundings of the first vehicle. Suspicious activity includes any activity indicative of potential criminal activity. In one embodiment, suspicious activity includes property destruction in the surroundings of the first vehicle, unauthorized physical interaction with the first vehicle, and a party wielding a weapon in the surroundings of the first vehicle. In one or more arrangements, property destruction includes damaging surrounding vehicles, arson, etc. Unauthorized physical interaction is, for example, attempted unauthorized access to the interior of the first vehicle and tampering with vehicle parts, such as windows, the undercarriage, etc. In any case, the system identifies the suspicious activity based on the sensor data.

In response to identifying suspicious activity in the surroundings of the vehicle, the system controls the second vehicle to perform a reactive maneuver. A reactive maneuver is, in one embodiment, maneuvering the second vehicle to restrict the movement of the first vehicle, maneuvering the second vehicle to restrict access to a door of the first vehicle, maneuvering the second vehicle to follow a party performing the suspicious activity, and maneuvering the second vehicle to block a view of the first vehicle to a party in the surroundings of the first vehicle. Further, in response to identifying suspicious activity, the system can, in one embodiment, request that a remote operator take control of the first vehicle. As such, the remote operator can move the first vehicle away from the suspicious activity. In one approach, the system controls the first vehicle to autonomously follow the second vehicle, where the first vehicle can autonomously follow the second vehicle using sensors, by receiving instructions from the second vehicle, and/or by processing sensor data from the second vehicle to determine an appropriate path for following the second vehicle. Accordingly, the system may control the second vehicle to traverse a path that leads the first vehicle away from the suspicious activity. In this way, the system improves the process of protecting a vehicle from theft and other crimes.

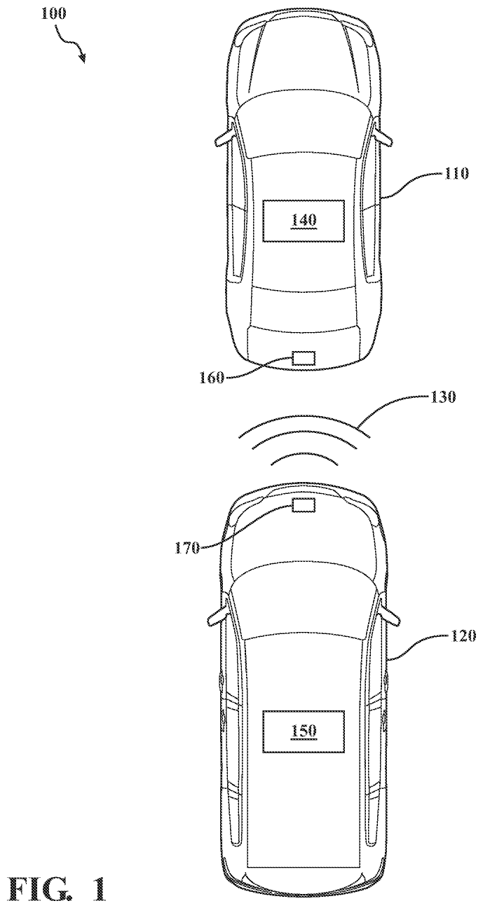

Referring to FIG. 1, an example of a hitchless towing configuration 100 is illustrated. The hitchless towing configuration includes a lead vehicle 110 and a following vehicle 120. The lead vehicle 110 and the following vehicle 120 can be vehicles with the same functionality as one another, where the lead vehicle 110 and the following vehicle 120 are fully functioning automobiles operable by human drivers. In one embodiment, the following vehicle 120 is a trailer, where the following vehicle 120 does not include all of the components of the lead vehicle 110 and where the following vehicle 120 cannot be controlled using a human driver. In any case, the lead vehicle 110 and the following vehicle 120 are connected via a wireless connection 130.

In one approach, the wireless connection 130 is established between the lead vehicle 110 and the following vehicle 120 using a handshake process. The wireless connection 130 can be established using a lead vehicle system 140 of the lead vehicle 110 and a following vehicle system 150 of the following vehicle 120. In one arrangement, the lead vehicle system 140 identifies a beacon transmitted from the following vehicle system 150. The lead vehicle system 140 recognizes the beacon and attempts to establish the wireless connection 130 by sending a secure message, including credentials of the lead vehicle 110 to the following vehicle 120. The wireless connection 130 is successfully established when the following vehicle system 150 receives the secure message from the lead vehicle system 140 and responds thereto with, for example, a session key or other information in support of a wireless communication link.

In response to establishing the wireless connection 130, the lead vehicle system 140 can send instructions to the following vehicle system 150. Instructions can include maneuvers (e.g., speed, acceleration, steering angle, etc.) for the following vehicle 120 to execute or a path of the lead vehicle 110. In any case, the instructions allow the following vehicle 120 to follow the lead vehicle 110 without any physical connection between the lead vehicle 110 and the following vehicle 120. In one embodiment, the lead vehicle 110 and the following vehicle 120 include lead vehicle sensors 160 and following vehicle sensors 170, respectively. Using the wireless connection 130, the lead vehicle system 140 and the following vehicle system 150 can share sensor data with one another. The sensor data can inform the vehicles about the position of the vehicles in relation to one another, obstacles on the path of travel, etc.

In one approach, the following vehicle 120 can follow the lead vehicle 110 using the sensor data. For example, the following vehicle sensors 170 can include imaging sensors for tracking the position and movement of the lead vehicle 110 in relation to the following vehicle 120. Based on the position and movement of the lead vehicle 110, the following vehicle system 150 can control the following vehicle 110 to follow the sensed path of the lead vehicle 120. In this way, the following vehicle 120 can follow the lead vehicle 110 if the wireless connection 130 is lost or obstructed.

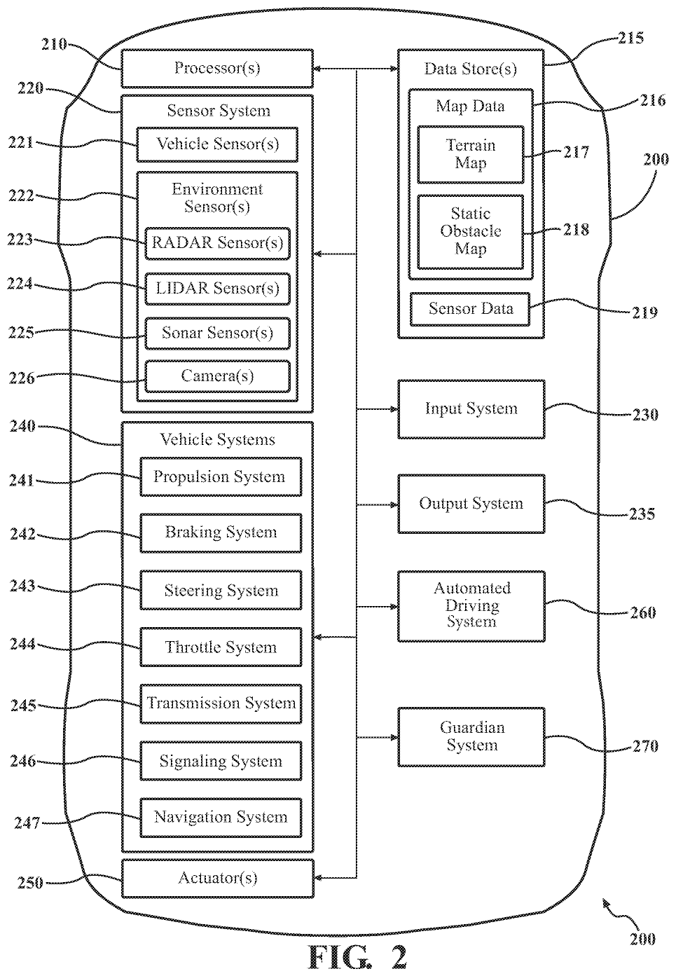

Referring to FIG. 2, a vehicle 200 is illustrated. As used herein, a “vehicle” is any form of motorized transport. In one or more implementations, the vehicle 200 is an automobile. While arrangements will be described herein with respect to automobiles, it will be understood that embodiments are not limited to automobiles. In some implementations, the vehicle 200 may be any robotic device or form of motorized transport that, for example, includes sensors to identify aspects of the surrounding environment and thus benefits from the functionality discussed herein associated with monitoring the surroundings of the vehicle 200 to identify suspicious activity. In one or more embodiments, the vehicle 200 is a lead vehicle (also referred to herein as “first vehicle”) wirelessly connected to a following vehicle (also referred to herein as “second vehicle”) in a hitchless towing configuration. Although the following discussion of the vehicle 200 will be from the perspective of the guardian system 270 being implemented in a lead vehicle, it should be understood that, in one or more configurations, the guardian system 270 can be implemented in the following vehicle.

The vehicle 200 also includes various elements. It will be understood that in various embodiments, it may not be necessary for the vehicle 200 to have all of the elements shown in FIG. 2. The vehicle 200 can have any combination of the various elements shown in FIG. 2. Further, the vehicle 200 can have additional elements to those shown in FIG. 2. In some arrangements, the vehicle 200 may be implemented without one or more of the elements shown in FIG. 2. While the various elements are shown as being located within the vehicle 200 in FIG. 2, it will be understood that one or more of these elements can be located external to the vehicle 200. Further, the elements shown may be physically separated by large distances.

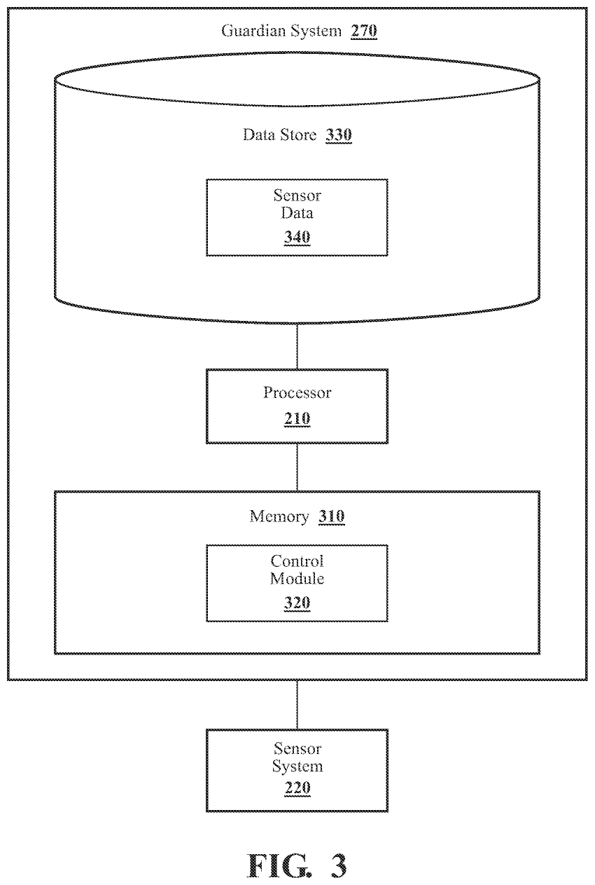

Some of the possible elements of the vehicle 200 are shown in FIG. 2 and will be described along with subsequent figures. However, a description of many of the elements in FIG. 2 will be provided after the discussion of FIGS. 3-8 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 200 includes a guardian system 270 that is implemented to perform methods and other functions as disclosed herein relating to improving the protection of the vehicle 200.

With reference to FIG. 3, one embodiment of the guardian system 270 of FIG. 2 is further illustrated. The guardian system 270 is shown as including one or more processor(s) 210 from the vehicle 200 of FIG. 2. Accordingly, the processor(s) 210 may be a part of the guardian system 270, the guardian system 270 may include a separate processor from the processor(s) 210 of the vehicle 200, or the guardian system 270 may access the processor(s) 210 through a data bus or another communication path. In one embodiment, the guardian system 270 includes a memory 310 that stores a control module 320. The memory 310 is a random-access memory (RAM), read-only memory (ROM), a hard-disk drive, a flash memory, or other suitable memory for storing the control module 320. The control module 320 is, for example, computer-readable instructions that, when executed by the processor(s) 210, cause the processor(s) 210 to perform the various functions disclosed herein.

With reference to FIG. 3, the control module 320 generally includes instructions that function to control the processor(s) 210 to receive data inputs from one or more sensors of the vehicle 200. The inputs are, in one embodiment, observations of one or more objects in an environment proximate to the vehicle 200 and/or other aspects about the surroundings. As provided for herein, the control module 320, in one embodiment, includes instructions that, when executed by the processor(s) 210, cause the processor(s) 210 to acquire sensor data 340 that includes at least camera images. In further arrangements, the control module acquires the sensor data 340 from further sensors, such as a radar sensor(s) 223, a LiDAR (light detection and ranging) sensor(s) 224, and other sensors as may be suitable for identifying objects in the surroundings of the vehicle 200.

Accordingly, the control module 320, in one embodiment, includes instructions that, when executed by the processor(s) 210, causes the processor(s) 210 to control the respective sensors to provide the data inputs in the form of the sensor data 340. Additionally, while the instructions of the control module 320 is discussed as causing the processor(s) 210 to control the various sensors to provide the sensor data 340, in one or more embodiments, the control module 320 can cause the processor(s) 210 to employ other techniques to acquire the sensor data 340 that are either active or passive. For example, the control module 320 may cause the processor(s) 210 to passively sniff the sensor data 340 from a stream of electronic information provided by the various sensors to further components within the vehicle 200. Moreover, the control module 320 may cause the processor(s) 210 to undertake various approaches to fuse data from multiple sensors when providing the sensor data 340 and/or from sensor data acquired over a wireless communication link. Thus, the sensor data 340, in one embodiment, represents a combination of perceptions acquired from multiple sensors.

In addition to objects in an environment proximate to the vehicle 200, the sensor data 340 may also include, for example, information about suspicious activity in the environment of the vehicle 200 and information about a following vehicle that the vehicle 200 connects to. Moreover, the control module 320, in one embodiment, causes the processor(s) 210 to control the sensors to acquire the sensor data 340 about an area that encompasses 360 degrees about the vehicle 200 in order to provide a comprehensive assessment of the surrounding environment. Of course, in alternative embodiments, the control module 320 may cause the processor(s) 210 to acquire the sensor data 340 about a forward direction alone when, for example, the vehicle 200 is not equipped with further sensors to include additional regions about the vehicle and/or the additional regions are not scanned due to other reasons.

In one approach, the control module 320 causes the processor(s) 210 to acquire the sensor data 340 from a following vehicle that is wirelessly connected to the vehicle 200. As previously discussed with reference to FIG. 1, the control module 320 causes the processor(s) 210 to receive sensor data from a following vehicle via the wireless connection between the vehicles. The sensor data 340 acquired from the following vehicle may include sensor data 340 encompassing an area not covered by the sensors of the vehicle 200 or an area that overlaps an area covered by the sensors of the vehicle 200. In one arrangement, the control module 320 causes the processor(s) 210 to control the following vehicle to maneuver to a position that is optimal for viewing the vehicle 200 when the vehicle 200 is parked and in an “off” state (i.e., when the engine of the vehicle 200 is off). A position that is optimal for viewing the vehicle 200 is, for example, a position that allows the following vehicle to view as much of the vehicle 200 as possible. As an example, the optimal position may be a position directly across from and facing the vehicle 200, a position on an elevated surface near the vehicle 200, a position parallel to the vehicle 200, or the like. In any case, the sensor data 340 acquired from the following vehicle can include 3D point cloud data, camera images and/or video from the cameras of the following vehicle, radar measurements, and so on pertaining to the vehicle 200.

In one arrangement, the control module 320 causes the processor(s) 210 to receive the sensor data 340 from nearby infrastructure. For example, the control module 320 may cause the processor(s) 210 to establish wireless connections with nearby infrastructure, such as home security systems, stoplights, etc., in the surroundings of the vehicle 200. The sensor data 340 includes, in one or more configurations, 3D point cloud data, camera images and/or video from cameras of the infrastructure, radar measurements, and so on pertaining to the vehicle 200. As previously discussed, the control module 320 may cause the processor(s) 210 to establish a wireless connection with the surrounding infrastructure using a handshake process. In one embodiment, the control module 320 causes the processor(s) 210 to receive the sensor data 340 from a remote server that collects the sensor data 340 from the nearby infrastructure. In any case, responsive to the guardian system 270 connecting to surrounding infrastructure and/or a remote server, the control module 320 causes the processor(s) 210 to acquire the sensor data 340. In this way, the control module 320 causes the processor(s) 210 to receive additional sensor coverage beyond what is acquired from sensors on-board the vehicle 200.

Moreover, in one embodiment, the guardian system 270 includes a data store 330. In one embodiment, the data store 330 is a database. The database is, in one embodiment, an electronic data structure stored in the memory 310 or another data store and that is configured with routines that can be executed by the processor(s) 210 for analyzing stored data, providing stored data, organizing stored data, and so on. Thus, in one embodiment, the data store 330 stores data used by the control module 320 in executing various functions. In one embodiment, the data store 330 includes the sensor data 340 along with, for example, metadata that characterize various aspects of the sensor data 340. For example, the metadata can include location coordinates (e.g., longitude and latitude), relative map coordinates or tile identifiers, time/date stamps from when the sensor data 340 was generated, and so on. In one embodiment, the data store 330 further includes characteristics indicative of suspicious activity in the surroundings of the vehicle 200 that are extracted from the sensor data 340, as generated by the processor(s) 210.

The control module 320, in one embodiment, is further causes the processor(s) 210 to perform additional tasks beyond controlling the respective sensors to acquire and provide the sensor data 340. For example, the control module 320 includes instructions that cause the processor(s) 210 to process the sensor data 340 to identify suspicious activity in the surroundings of the vehicle 200. In one arrangement, the control module 320 causes the processor(s) 210 to process the sensor data 340 by using a machine learning algorithm embedded within the control module 320, such as a convolutional neural network (CNN), which may cause the processor(s) 210 to perform semantic segmentation over the sensor data 340 from which suspicious activity is identified and extracted. Of course, in further aspects, the control module 320 may cause the processor(s) 210 to employ different machine learning algorithms or implement different approaches for performing the associated functions, which can include deep convolutional encoder-decoder architectures, or another suitable approach that generates information about the separate objects represented in the sensor data 340. Whichever particular approach the control module 320 causes the processor(s) 210 to implement, the control module 320 causes the processor(s) 210 to provide an output with semantic labels identifying features about suspicious activity in the sensor data 340.

Accordingly, the control module 320 causes the processor(s) 210 to correlate identified features with suspicious activity. Suspicious activity includes, in one or more embodiments, property destruction in the surroundings of the vehicle 200, unauthorized physical interaction with the vehicle 200, and a party wielding a weapon in the surroundings of the vehicle 200. Property destruction includes, for example, damaging surrounding vehicles, such as a following vehicle wirelessly connected to the vehicle 200, arson, etc. Unauthorized physical interaction is, for example, attempted unauthorized access to the interior of the vehicle 200 (e.g., when an unauthorized user pulls on a door handle of the vehicle 200) and tampering with vehicle parts, such as windows, the undercarriage, etc. For example, the control module 320 may cause the processor(s) 210 to process the sensor data 340 to identify suspicious activity when the sensor data 340 indicates that an unauthorized user (i.e., a user that is not recognized as an owner or approved driver of the vehicle 200 or a user who does not have a key to the vehicle 200) is attempting to open a door handle of the vehicle 200, break the windows of the vehicle 200, and steal parts, such as the catalytic converter, from the vehicle 200. As another example, the control module 320 may cause the processor(s) 210 to identify suspicious activity when the sensor data 340 indicates that an unauthorized user is starting a fire near the vehicle 200, breaking into surrounding vehicles, and/or wielding a weapon, such as a club, bat, gun, knife near the vehicle 200.

Responsive to identifying the suspicious activity in the surroundings of the vehicle 200, the control module 320, in one or more arrangements, causes the processor(s) 210 to control the following vehicle wirelessly connected to the vehicle 200 to perform a reactive maneuver. In one approach, the following vehicle is configured to autonomously follow the vehicle 200 under normal operations using a wireless connection. As previously discussed with reference to FIG. 1, the following vehicle can follow the vehicle 200 by receiving instructions from the vehicle 200. As such, where the following vehicle is configured to receive and execute instructions from the vehicle 200, the control module 320 can cause the processor(s) 210 to control the following vehicle to perform a reactive maneuver in favor of the vehicle 200.

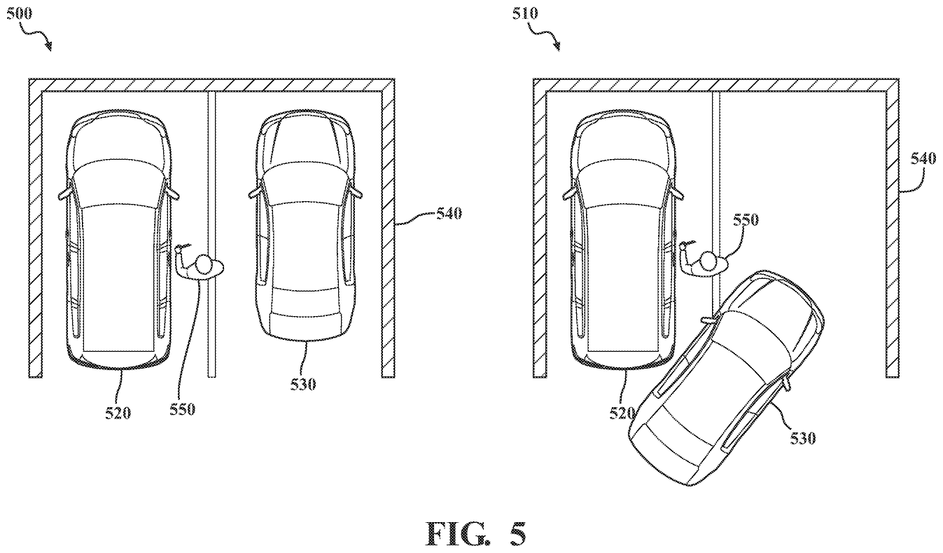

Reactive maneuvers include, for example, maneuvering the following vehicle to restrict the movement of the vehicle 200, maneuvering the following vehicle to restrict access to a door of the vehicle 200, maneuvering the following vehicle to follow a party performing the suspicious activity, and maneuvering the following vehicle to block a view of the vehicle 200 to a party in the surroundings of the vehicle 200. The reactive maneuvers of the following vehicle will be discussed in further detail in relation to FIGS. 5-8.

Where the reactive maneuver is restricting movement of the vehicle 200, the control module 320 causes the processor(s) 210 to controls the following vehicle to move to a position that does not allow the vehicle 200 to move forward, backwards, etc. and stay in that position until the suspicious activity is no longer present. Where the reactive maneuver is restricting access to a door of the vehicle 200, the control module 320 cause the processor(s) 210 to control the following vehicle to move to a side of the vehicle 200 that a suspicious party is attempting to access. For example, if a party wielding a bat is approaching the right side of the vehicle 200, the control module 320 cause the processor(s) 210 to control the following vehicle to position itself close enough to the right doors of the vehicle 200 so that the suspicious party cannot enter the doors and so that the following vehicle does not collide with the vehicle 200.

Where the reactive maneuver is following a party performing the suspicious activity, the control module 320 may cause the processor(s) 210 to control the following vehicle to follow the suspicious party by tracking the suspicious party using sensors of the following vehicle. For example, the sensors of the following vehicle can acquire sensor data related to the location, speed, and direction of travel of the suspicious party. Where the reactive maneuver is blocking a view of the vehicle 200, the control module 320 cause the processor(s) 210 to control the following vehicle to maneuver to a position that optimally occludes the vehicle 200 from suspicious parties in the area. For example, if the sensor data 340 indicates that a suspicious party (e.g., a person with a weapon) has previously broken into other vehicles in the surroundings of the vehicle 200 and that the party will be approaching the front end of the vehicle 200 in approximately 5 minutes, the control module 320 cause the processor(s) 210 to control the following vehicle to move in front of the front end of the vehicle 200 prior to the vehicle 200 being in the line of sight of the suspicious party.

In one embodiment, responsive to identifying the suspicious activity, the control module 320 causes the processor(s) 210 to control the vehicle 200 to autonomously follow the following vehicle. As previously discussed in relation to FIG. 1, the following vehicle may be a fully functioning automobile with systems and functions identical to the vehicle 200. The vehicle 200 can follow the following vehicle by, as previously discussed in relation to FIG. 1, receiving instructions via a wireless communication link between the vehicles or by following the following vehicle using sensors of the vehicle 200. Accordingly, in one approach, the reactive maneuver includes traversing a path that leads the vehicle 200 away from the suspicious activity. For example, where the suspicious activity is occurring to the left of the vehicle 200, the control module 320 cause the processor(s) 210 to control the following vehicle to move to the right until the suspicious activity is no longer in the surroundings of the vehicle 200.

In one configuration, responsive to the control module 320 causing the processor(s) 210 to identify the suspicious activity, the control module 320 causes the processor(s) 210 to request a remote operator to control the vehicle 200. A remote operator is anyone capable of controlling the vehicle 200 from a remote facility, where the operator can be an owner of the vehicle 200 or an authorized operator of the vehicle 200. The remote operator may control the vehicle 200 by entering inputs on a human machine interface (HMI), such as via a computer screen, smartphone application, etc. In one embodiment, the control module 320 causes the processor(s) 210 to send sensor data about the surroundings of the vehicle 200 to the remote operator, where the sensor data includes a video feed showing the surroundings of the vehicle 200. Accordingly, when a remote operator accepts the request, the remote operator can control the vehicle 200 to move to a location away from the suspicious activity.

In one or more arrangements, the guardian system 270 is implemented in the following vehicle. For example, in one embodiment, the control module 320 cause the processor(s) 210 to acquire the sensor data 340 from the vehicle 200 and process the sensor data 340 onboard the guardian system 270 of the following vehicle to identify the suspicious behavior and to control the following vehicle to perform a reactive maneuver. As another example, instead of the guardian system 270 of the vehicle 200 controlling the following vehicle to perform a reactive maneuver, where the guardian system 270 is implemented in the vehicle 200, the control module 320 causes the processor(s) 210 to identify the suspicious activity in the surroundings of the following vehicle and controls the vehicle 200 to perform the reactive maneuver. In this way, the guardian system 270 improves protecting a vehicle, whether the vehicle is a lead vehicle or following vehicle, from suspicious activity.

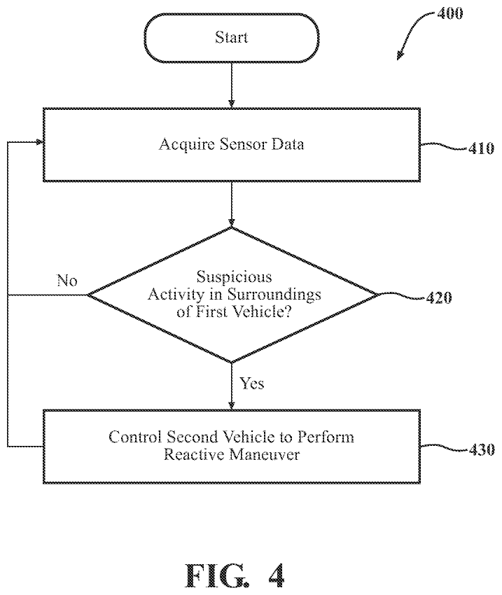

Additional aspects of protecting a vehicle will be discussed in relation to FIG. 4. FIG. 4 illustrates a flowchart of a method 400 that is associated with protecting a first vehicle using a second vehicle. Method 400 will be discussed from the perspective of the guardian system 270 of FIGS. 2 and 3. While method 400 is discussed in combination with the guardian system 270, it should be appreciated that the method 400 is not limited to being implemented within the guardian system 270 but is instead one example of a system that may implement the method 400. Further, while the method 400 and the guardian system 270 are discussed as being implemented in the vehicle 200, it should be understood that the guardian system 270 may be implemented in a following vehicle that may be similar to the vehicle 200.

At 410, the control module 320 includes instructions that, when executed by the processor(s) 210, cause the processor(s) 210 to control the sensor system 220 to acquire the sensor data 340. In one embodiment, the control module 320 cause the processor(s) 210 to control the radar sensor(s) 223 and the camera 226 of the vehicle 200 to observe the surrounding environment. Alternatively, or additionally, the control module 320 cause the processor(s) 210 to control the camera 226 and the LIDAR sensor(s) 224 or another set of sensors to acquire the sensor data 340. As part of controlling the sensors to acquire the sensor data 340, it is generally understood that the sensors acquire the sensor data 340 of a region around the vehicle 200 with data acquired from different types of sensors generally overlapping in order to provide for a comprehensive sampling of the surrounding environment at each time step. The sensor data 340 of the region around the vehicle 200 could include data related to objects in the surroundings of the vehicle 200 or data related to the vehicle 200 itself. In general, the sensor data 340 need not be of the exact same bounded region in the surrounding environment but should include a sufficient area of overlap such that distinct aspects of the area can be correlated. Thus, the control module 320, in one embodiment, causes the processor(s) 210 to control the sensors to acquire the sensor data 340 of the surrounding environment.

The control module 320 may also cause the processor(s) 210 to acquire the sensor data 340 from a following vehicle wirelessly connected to the vehicle 200, where the sensor data 340 captured by the following vehicle encompasses the surroundings of the vehicle 200. In one arrangement, the control module 320 causes the processor(s) 210 to control the following vehicle to maneuver to a position that is optimal for viewing the vehicle 200 when the vehicle 200 is parked and in an “off” state (i.e., when the engine of the vehicle 200 is off). A position that is optimal for viewing the vehicle 200 is, for example, a position that allows the following vehicle to view as much of the vehicle 200 as possible or a position that allows the vehicle 200 and the following vehicle to collectively achieve optimal sensor coverage of the vehicle 200. Additionally, the control module 320 may cause the processor(s) 210 to acquire the sensor data 340 from nearby infrastructure connected to or accessible by the vehicle 200.

Moreover, in further embodiments, control module 320 cause the processor(s) 210 to control the sensors to acquire the sensor data 340 at successive iterations or time steps. Furthermore, the control module 320, in one embodiment, causes the processor(s) 210 to execute one or more of the noted functions in parallel for separate observations in order to maintain updated perceptions. Additionally, as previously noted, the control module 320, when acquiring data from multiple sensors, causes the processor(s) 210 to fuse the data together to form the sensor data 340 and to provide for improved determinations of detection, location, and so on.

At 420, the control module 320 includes instructions that, when executed by the processor(s) 210, causes the processor to identify whether there is suspicious activity in the surroundings of the vehicle 200. In one embodiment, the control module 320 cause the processor(s) 210 to identify suspicious activity by extracting features from acquired image, radar, LiDAR and/or video data. In various approaches, the control module 320 cause the processor(s) 210 to employ different object recognition techniques to identify suspicious activity. The particular technique employed to identify the entrance may depend on available sensors within the vehicle 200, computational abilities (e.g., processor power) of the vehicle 200, and so on.

In one approach, the control module 320 causes the processor(s) 210 to use a machine learning algorithm embedded within the control module 320 or elsewhere within the guardian system 270, such as a convolutional neural network (CNN), to perform semantic segmentation over the sensor data 340 from which suspicious activity is derived. Of course, in further aspects, the control module 320 may cause the processor(s) 210 to employ different machine learning algorithms or implements different approaches for performing the associated functions, which can include deep convolutional encoder-decoder architectures, or another suitable approach that generates semantic labels for the separate object classes represented in the image. Whichever particular approach the control module 320 causes the processor(s) 210 to implement, the control module 320 causes the processor(s) 210 to provide an output with semantic labels identifying objects represented in the sensor data 340. In this way, the control module 320 causes the processor(s) 210 to identify objects in the surroundings of the vehicle 200.

In one embodiment, the control module 320 may cause the processor(s) 210 to process image and/or video data to identify specific characteristics indicative of suspicious activity, such as property destruction, unauthorized physical interaction with the vehicle 200, and a party wielding a weapon in the surroundings of the vehicle 200. For example, the control module 320 may cause the processor(s) 210 to process the sensor data 340 to identify arson, theft of other vehicles, and destruction of other vehicles in the surroundings of the vehicle 200.

In one arrangement, the control module 320 causes the processor(s) 210 to identify suspicious activity by analyzing the movement, location, and characteristics of a party in the surroundings of the vehicle 200. As an example, the control module 320 can cause the processor(s) 210 to identify what a nearby party is wearing (e.g., a ski mask, all black clothing, gloves, or other clothing indicative of someone trying to hide their identity or act discretely), what a nearby party is holding (e.g., whether a nearby party is wielding a weapon/blunt object, such as a bat, club, gun, knife, etc.), how the nearby party is acting (e.g., whether the party is peering into vehicles, walking towards the vehicle 200, loitering, checking their surroundings, etc.), and the location of the suspicious party in relation to the vehicle 200. The control module 320 can also cause the processor(s) 210 to process the sensor data 340 to identify how a suspicious party is interacting with the vehicle 200. For example, the control module 320 can cause the processor(s) 210 to identify if the party is in close proximity to the vehicle 200, looking inside of the vehicle 200, touching the vehicle 200, manipulating components of the vehicle 200 (e.g., pulling on a door handle or trunk handle of the vehicle 200, attempting to disassemble the vehicle 200 by attempting to steal tires, a catalytic converter, or other components of the vehicle 200, etc.), and/or otherwise damaging the vehicle 200 (e.g., by applying force to the vehicle 200). In any case, if the control module 320 causes the processor(s) 210 to identify suspicious activity in the surroundings of the vehicle 200, the control module 320 causes the processor(s) 210 to control a following vehicle connected to the vehicle 200 to perform a reactive maneuver. Otherwise, the control module 320 causes the processor(s) 210 to acquire the sensor data 340, as discussed at step 410.

At 430, the control module 320 includes instructions that, when executed by the processor(s) 210, cause the processor(s) 210 to control the following vehicle to perform a reactive maneuver. The following vehicle is configured, in one or more embodiments, to autonomously follow the vehicle 200 during normal driving operations. In one approach, the following vehicle is configured to receive instructions for following the vehicle and/or to receive sensor data acquired by the vehicle 200. Accordingly, the control module 320, may cause the processor(s) 210 to send instructions for executing the reactive maneuver to the following vehicle. The reactive maneuver is, for example, maneuvering the following vehicle to restrict the movement of the vehicle 200, maneuvering the following vehicle to restrict access to a door of the vehicle 200, maneuvering the following vehicle to follow a party performing the suspicious activity, and maneuvering the following vehicle to block a view of the vehicle 200 to a party in the surroundings of the first vehicle.

In one approach, the control module 320 causes the processor(s) 210 to control the following vehicle to restrict movement of the vehicle 200 in response to identifying that the suspicious activity includes an unauthorized user gaining access to the interior of the vehicle 200. As an example of controlling the following vehicle to restrict movement of the vehicle 200, the control module 320 may cause the processor(s) 210 to control the following vehicle to position itself in a manner that blocks an unauthorized user from moving the vehicle 200 without also striking the following vehicle (e.g., maneuvering the following vehicle to a position directly in front of/behind the vehicle 200, an angled position that blocks movement of the vehicle 200 to the side and rear/front, etc.) and surrounding obstacles (e.g., parking structure walls, surrounding vehicles, etc.).

In one embodiment, the control module 320 causes the processor(s) 210 to control the following vehicle to restrict access to a door of the vehicle 200, to follow a suspicious party, and/or to block the view of the vehicle 200 when the suspicious party is in the vicinity of the vehicle 200 and wielding a weapon or otherwise causing property damage in the surroundings of the vehicle 200 without actually breaking into or touching the vehicle 200. Where the reactive maneuver includes restricting access to a door of the vehicle 200, the control module 320 may cause the processor(s) 210 to control the following vehicle to physically block doors on a side of the vehicle 200 being approached by an unauthorized user or on a side where suspicious activity is occurring. Where the reactive maneuver includes following a party performing the suspicious activity, the control module 320 can, in one arrangement, cause the processor(s) 210 to control the following vehicle to follow and track the suspicious party using sensors of the following vehicle. In one arrangement, the control module 320 causes the processor(s) 210 to control the following vehicle to follow the party at a predefined distance (e.g., 1 meter, 5 meters, etc.). Where the reactive maneuver includes blocking a view of a suspicious party, the control module 320 may cause the processor(s) 210 to control the following vehicle to block the vehicle 200 from the perspective of the suspicious party (e.g., if the suspicious party is in front of the vehicle 200, the control module 320 causes the processor(s) 210 to control the following vehicle to move in front of the vehicle 200).

The reactive maneuver may further include outputting an audible and/or visual alarm of the following vehicle. For example, the control module 320 can cause the processor(s) 210 to control the following vehicle to flash its hazard lights and sound an audible alarm in response to suspicious activity in the surroundings of the vehicle 200. In one approach, the control module 320 can cause the processor(s) 210 to control both the vehicle 200 and the following vehicle to output audible and visual alerts. Further, in one embodiment, the control module 320 causes the processor(s) 210 to alert a designated party of the suspicious activity. As an example, the control module 320 may cause the processor(s) 210 to send a notification to a personal device of the owner of the vehicle 200 or may alert first responders of the suspicious activity.

In one arrangement, the reactive maneuver includes requesting that a remote operator take control of the vehicle 200. The control module 320, in one configuration, causes the processor(s) 210 to communicate with a device of the remote operator (e.g., a smartphone, computer, tablet, etc.) to notify the remote operator of the current condition of the vehicle 200. In one arrangement, the control module 320 causes the processor(s) 210 to send a video feed encompassing the surroundings of the vehicle 200 to the device of the remote operator. The remote operator can, using a human machine interface (HMI), control the vehicle 200 by entering inputs on the HMI, where the inputs control the speed, acceleration, direction of travel, etc., of the vehicle 200.

In one embodiment, the control module 320 can cause the processor(s) 210 to control the vehicle 200 to follow the following vehicle. For example, where the suspicious activity is property destruction near the vehicle 200 and/or where the suspicious party is near the vehicle 200, the control module 320 causes the processor(s) 210 to control the vehicle 200 to follow the following vehicle by receiving instructions from the following vehicle. In one approach, where the vehicle 200 is configured to autonomously follow the following vehicle, the control module 320 causes the processor(s) 210 to control the following vehicle to traverse a path that leads the vehicle 200 away from the suspicious activity. As an example, where the suspicious activity is vehicles to the left of the vehicle 200 being broken into, the control module 320 causes the processor(s) 210 to control the following vehicle to traverse a path that leads the vehicle 200 far enough to the right of the suspicious activity so that the suspicious activity is no longer in the surroundings of the vehicle 200. If the control module 320 causes the processor(s) 210 to the following vehicle to move the vehicle 200 to a new location, the control module 320, in one approach, causes the processor(s) 210 to inform the owner of the vehicle 200 of the new location of the vehicle 200.

After controlling the following vehicle to successfully perform the reactive maneuver, the control module 320 causes the processor(s) 210 to continue to acquire the sensor data 340 about the surroundings of the vehicle 200 at step 410. In this way, the guardian system 270 continuously monitors and protects the vehicle 200. FIGS. 5-8 will now be discussed to illustrate examples of reactive maneuvers that can be performed by the following vehicle.

With reference to FIGS. 5-8, the terms “first vehicle” and “second vehicle” refer to a lead vehicle and following vehicle in a hitchless towing configuration as discussed in relation to FIG. 1, respectively. FIGS. 5-8 will be discussed from the perspective of the guardian system 270 of FIGS. 2 and 3. Referring to FIG. 5, a sequence associated with a second vehicle restricting movement of a first vehicle is illustrated. At timestep 500, a first vehicle 520 and a second vehicle 530 are parked parallel and directly next to one another in parking spaces. The parking spaces are surrounded by a wall 540, where the wall 540 restricts movement of the first vehicle 520 and the second vehicle 530. Further, suspicious activity 550 is present in the surroundings of the first vehicle 520. At timestep 500, the control module 320 causes the processor(s) 210 to identify the suspicious activity 550. The suspicious activity 550 is occurring in close proximity of the first vehicle 520, where the suspicious activity 550 is associated with a party making an attempt to break into and move the first vehicle 520. At timestep 510, responsive to identifying the suspicious activity 550, the control module 320 causes the processor(s) 210 to control the second vehicle 530 to restrict movement of the first vehicle 520. As illustrated in timestep 510, the second vehicle 530 is positioned at an angle that prevents the first vehicle 520 from moving without running into the wall 540 or the second vehicle 530.

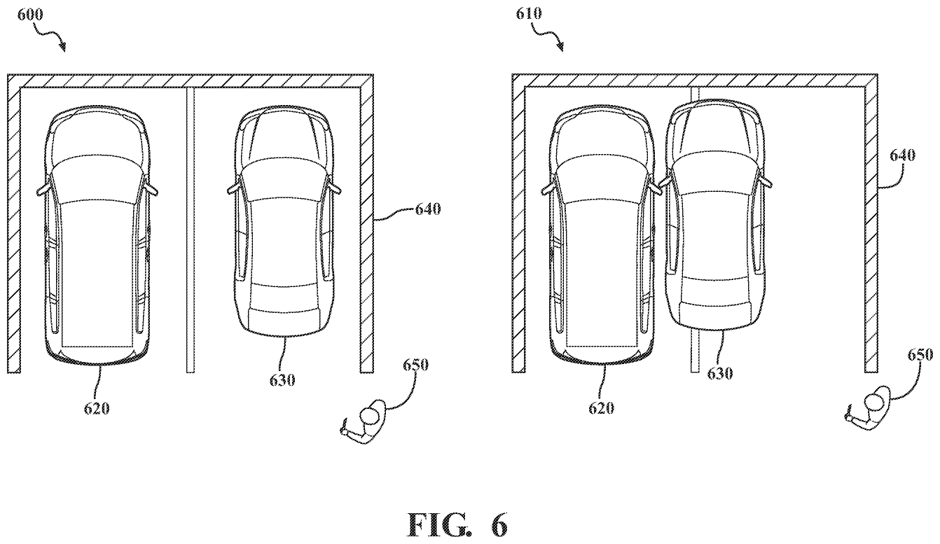

Referring to FIG. 6, a sequence associated with a second vehicle restricting access to a door of a first vehicle is illustrated. At timestep 600 a first vehicle 620 and a second vehicle 630 are parked parallel and directly next to one another in parking spaces. The parking spaces are surrounded by a wall 640, where the wall 640 restricts movement of the first vehicle 620 and the second vehicle 630. Further, suspicious activity 650 is present in the surroundings of the first vehicle 520. At timestep 600, the control module 320 causes the processor(s) 210 to identify the suspicious activity 650. The suspicious activity 650 is associated with a party posing a threat to the first vehicle 620 without tampering with the first vehicle 620. For example, the suspicious activity 650 may include a party wielding a weapon or the party destroying property in the surroundings of the first vehicle 620. As shown in timestep 600, the suspicious activity is occurring to the right of the first vehicle 620. At timestep 610, responsive to identifying the suspicious activity 650, the control module 320 causes the processor(s) 210 to control the second vehicle 630 to restrict access to doors of the first vehicle 620. Because the suspicious activity 650 is identified as being on the right side of the first vehicle 620, the control module 320 causes the processor(s) 210 to control the second vehicle 630 to restrict access to the doors on the right side of the first vehicle 620 by positioning the second vehicle 630 in a manner that makes it impossible for an unauthorized user to enter the first vehicle 620 from the right side of the first vehicle 620.

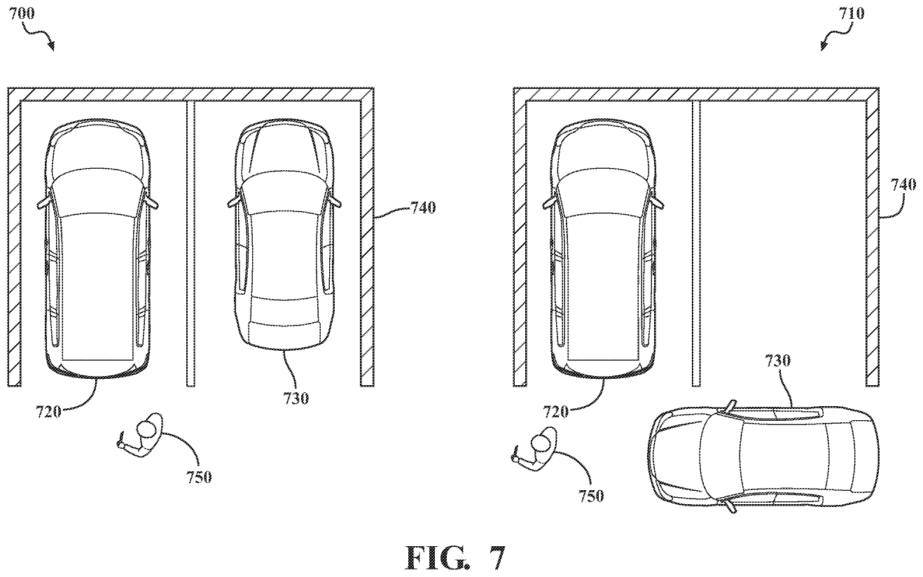

FIG. 7 illustrates a sequence associated with a second vehicle restricting following a suspicious party in the surroundings of a first vehicle. At timestep 700 a first vehicle 720 and a second vehicle 730 are parked parallel and directly next to one another in parking spaces. The parking spaces are surrounded by a wall 740, where the wall 740 restricts movement of the first vehicle 720 and the second vehicle 730. Further, suspicious activity 750 is present in the surroundings of the first vehicle 720. At timestep 700, the control module 320 causes the processor(s) 210 to identify the suspicious activity 750. The suspicious activity 750 is associated with a party posing a threat to the first vehicle 720 without tampering with the first vehicle 720. As illustrated in FIG. 7, the suspicious activity 750 may include a party wielding a weapon in the surroundings of the first vehicle 720. As shown in timestep 700, the suspicious activity is occurring to the right of the first vehicle 720. At timestep 710, responsive to identifying the suspicious activity 750, the control module 320 causes the processor(s) 210 to control the second vehicle 730 to follow the suspicious activity 750, where the suspicious activity 750 is a party wielding a weapon. The control module 320 can cause the processor(s) 210 to control the second vehicle 730 to follow the party at a predefined distance using one or more sensors of the second vehicle 730. In this way, the party is deterred from damaging the first vehicle 720 due to the surveillance of the second vehicle 730.

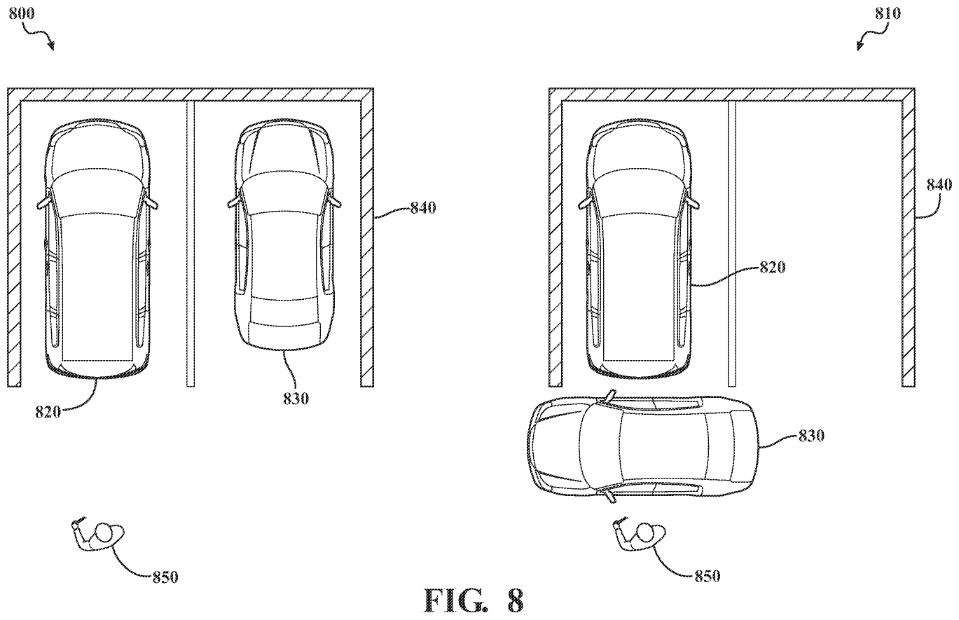

FIG. 8 illustrates a sequence associated with a second vehicle blocking the view of a first vehicle to a party in the surroundings of the first vehicle. At timestep 800 a first vehicle 820 and a second vehicle 830 are parked parallel and directly next to one another in parking spaces. The parking spaces are surrounded by a wall 840, where the wall 840 restricts movement of the first vehicle 820 and the second vehicle 830. Further, suspicious activity 850 is present in the surroundings of the first vehicle 820. At timestep 800, the control module 320 causes the processor(s) 210 to identify the suspicious activity 850. The suspicious activity 850 is associated with a party posing a threat to the first vehicle 820 without tampering with the first vehicle 820. As illustrated in FIG. 8, the suspicious activity 850 may include a party wielding a weapon in front of the first vehicle 820. Further, as shown in at timestep 800 of FIG. 8, the first vehicle 820 may not be in the line of sight of the party. At timestep 810, responsive to identifying the suspicious activity 850, the control module 320 causes the processor(s) 210 to control the second vehicle 830 to block the view of the first vehicle 820 from the suspicious activity (i.e., the suspicious party) 850. In this way, suspicious parties are deterred from tampering with or otherwise damaging the first vehicle 820 as it is out of their line of sight. In this way, the guardian system 270 improves providing protections to a first vehicle using a second vehicle.

FIG. 2 will now be discussed in full detail as an example environment within which the system and methods disclosed herein may operate. In some instances, the vehicle 200 is configured to switch selectively between different modes of operation/control according to the direction of one or more modules/systems of the vehicle 200. In one approach, the modes include: 0, no automation; 1, driver assistance; 2, partial automation; 3, conditional automation; 4, high automation; and 5, full automation. In one or more arrangements, the vehicle 200 can be configured to operate in only a subset of possible modes.

In one or more embodiments, the vehicle 200 is an autonomous vehicle. As used herein, “autonomous vehicle” refers to a vehicle that is capable of operating in an autonomous mode (e.g., category 5, full automation). “Autonomous mode” refers to navigating and/or maneuvering the vehicle 200 along a travel route using one or more computing systems to control the vehicle 200 with minimal or no input from a human driver. In one or more embodiments, the vehicle 200 is either highly automated or completely automated. In one embodiment, the vehicle 200 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 200 along a travel route.

The vehicle 200 can include one or more processor(s) 210. In one or more arrangements, the processor(s) 210 can be a main processor of the vehicle 200. For instance, the processor(s) 210 can be an electronic control unit (ECU), and application specific integrated circuit (ASIC), a microprocessor, etc. The vehicle 200 can include one or more data store(s) 215 for storing one or more types of data. The data store(s) 215 can include volatile and/or non-volatile memory. Examples of data store(s) 215 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, and hard drives. The data store(s) 215 can be a component of the processor(s) 210, or the data store(s) 215 can be operatively connected to the processor(s) 210 for use thereby. The term “operatively connected,” as used throughout this description, can include direct or indirect connections, including connections without direct physical contact.

In one or more arrangements, the one or more data store(s) 215 can include map data 216. The map data 216 can include maps of one or more geographic areas. In some instances, the map data 216 can include information or data on roads, traffic control devices, road markings, structures, features, and/or landmarks in the one or more geographic areas. The map data 216 can be in any suitable form. In some instances, the map data 216 can include aerial views of an area. In some instances, the map data 216 can include ground views of an area, including 360-degree ground views. The map data 216 can include measurements, dimensions, distances, and/or information for one or more items included in the map data 216 and/or relative to other items included in the map data 216. The map data 216 can include a digital map with information about road geometry.

In one or more arrangements, the map data 216 can include one or more terrain map(s) 217. The terrain map(s) 217 can include information about the terrain, roads, surfaces, and/or other features of one or more geographic areas. The terrain map(s) 217 can include elevation data in the one or more geographic areas. The terrain map(s) 217 can define one or more ground surfaces, which can include paved roads, unpaved roads, land, and other things that define a ground surface.

In one or more arrangements, the map data 216 can include one or more static obstacle map(s) 218. The static obstacle map(s) 218 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 218 can have location data, size data, dimension data, material data, and/or other data associated with it. The static obstacle map(s) 218 can include measurements, dimensions, distances, and/or information for one or more static obstacles. The static obstacle map(s) 218 can be high quality and/or highly detailed. The static obstacle map(s) 218 can be updated to reflect changes within a mapped area.

The one or more data store(s) 215 can include sensor data 219. In this context, “sensor data” means any information about the sensors that the vehicle 200 is equipped with, including the capabilities and other information about such sensors. As will be explained below, the vehicle 200 can include the sensor system 220. The sensor data 219 can relate to one or more sensors of the sensor system 220. As an example, in one or more arrangements, the sensor data 219 can include information about one or more LIDAR sensor(s) 224 of the sensor system 220.

In some instances, at least a portion of the map data 216 and/or the sensor data 219 can be located in one or more data store(s) 215 located onboard the vehicle 200. Alternatively, or in addition, at least a portion of the map data 216 and/or the sensor data 219 can be located in one or more data stores 225 that are located remotely from the vehicle 200.

As noted above, the vehicle 200 can include the sensor system 220. The sensor system 220 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 220 includes a plurality of sensors, the sensors may function independently or two or more of the sensors may function in combination. The sensor system 220 and/or the one or more sensors can be operatively connected to the processor(s) 210, the data store(s) 215, and/or another element of the vehicle 200. The sensor system 220 can produce observations about a portion of the environment of the vehicle 200 (e.g., nearby vehicles).

The sensor system 220 can include any suitable type of sensor. Various examples of different types of sensors will be described herein. However, it will be understood that the embodiments are not limited to the particular sensors described. The sensor system 220 can include one or more vehicle sensor(s) 221. The vehicle sensor(s) 221 can detect information about the vehicle 200 itself. In one or more arrangements, the vehicle sensor(s) 221 can be configured to detect position and orientation changes of the vehicle 200, such as, for example, based on inertial acceleration. In one or more arrangements, the vehicle sensor(s) 221 can include one or more accelerometers, one or more gyroscopes, an inertial measurement unit (IMU), a dead-reckoning system, a global navigation satellite system (GNSS), a global positioning system (GPS), a navigation system 247, and/or other suitable sensors. The vehicle sensor(s) 221 can be configured to detect one or more characteristics of the vehicle 200 and/or a manner in which the vehicle 200 is operating. In one or more arrangements, the vehicle sensor(s) 221 can include a speedometer to determine a current speed of the vehicle 200.

Alternatively, or in addition, the sensor system 220 can include one or more environment sensors 222 configured to acquire data about an environment surrounding the vehicle 200 in which the vehicle 200 is operating. “Surrounding environment data” includes data about the external environment in which the vehicle is located or one or more portions thereof. For example, the one or more environment sensors 222 can be configured to sense obstacles in at least a portion of the external environment of the vehicle 200 and/or data about such obstacles. Such obstacles may be stationary objects and/or dynamic objects. The one or more environment sensors 222 can be configured to detect other things in the external environment of the vehicle 200, such as, for example, lane markers, signs, traffic lights, traffic signs, lane lines, crosswalks, curbs proximate the vehicle 200, off-road objects, etc.

Various examples of sensors of the sensor system 220 will be described herein. The example sensors may be part of the one or more environment sensors 222 and/or the one or more vehicle sensor(s) 221. However, it will be understood that the embodiments are not limited to the particular sensors described.

As an example, in one or more arrangements, the sensor system 220 can include one or more of each of the following: radar sensor(s) 223, LIDAR sensor(s) 224, sonar sensors 225, weather sensors, haptic sensors, locational sensors, and/or one or more cameras 226. In one or more arrangements, the one or more cameras 226 can be high dynamic range (HDR) cameras, stereo or infrared (IR) cameras.

The vehicle 200 can include an input system 230. An “input system” includes components or arrangement or groups thereof that enable various entities to enter data into a machine. The input system 230 can receive an input from a vehicle occupant. The vehicle 200 can include an output system 235. An “output system” includes one or more components that facilitate presenting data to a vehicle occupant.

The vehicle 200 can include one or more vehicle systems 240. Various examples of the one or more vehicle systems 240 are shown in FIG. 2. However, the vehicle 200 can include more, fewer, or different vehicle systems. It should be appreciated that although particular vehicle systems are separately defined, each or any of the systems or portions thereof may be otherwise combined or segregated via hardware and/or software within the vehicle 200. The vehicle 200 can include a propulsion system 241, a braking system 242, a steering system 243, throttle system 244, a transmission system 245, a signaling system 246, and/or a navigation system 247. Each of these systems can include one or more devices, components, and/or a combination thereof, now known or later developed.

The navigation system 247 can include one or more devices, applications, and/or combinations thereof, now known or later developed, configured to determine the geographic location of the vehicle 200 and/or to determine a travel route for the vehicle 200. The navigation system 247 can include one or more mapping applications to determine a travel route for the vehicle 200. The navigation system 247 can include a global positioning system, a local positioning system or a geolocation system.

The processor(s) 210, the guardian system 270, and/or the autonomous driving system 260 can be operatively connected to communicate with the vehicle systems 240 and/or individual components thereof. For example, returning to FIG. 2, the processor(s) 210 and/or the autonomous driving system 260 can be in communication to send and/or receive information from the vehicle systems 240 to control the movement of the vehicle 200. The processor(s) 210, the guardian system 270, and/or the autonomous driving system 260 may control some or all of the vehicle systems 240 and, thus, may be partially or fully autonomous as defined by SAE 0 to 5.

The processor(s) 210, the guardian system 270, and/or the autonomous driving system 260 can be operatively connected to communicate with the vehicle systems 240 and/or individual components thereof. For example, returning to FIG. 2, the processor(s) 210, the guardian system 270, and/or the autonomous driving system 260 can be in communication to send and/or receive information from the vehicle systems 240 to control the movement. of the vehicle 200. The processor(s) 210, the guardian system 270, and/or the autonomous driving system 260 may control some or all of the vehicle systems 240.

The processor(s) 210, the guardian system 270, and/or the autonomous driving system 260 may be operable to control the navigation and maneuvering of the vehicle 200 by controlling one or more of the vehicle systems 240 and/or components thereof. For instance, when operating in an autonomous mode, the processor(s) 210, the guardian system 270, and/or the autonomous driving system 260 can control the direction and/or speed of the vehicle 200. The processor(s) 210, the guardian system 270, and/or the autonomous driving system 260 can cause the vehicle 200 to accelerate, decelerate ( ) and/or change direction. As used herein, “cause” or “causing” means to make, force, compel, direct, command, instruct, and/or enable an event or action to occur or at least be in a state where such event or action may occur, either in a direct or indirect manner.

The vehicle 200 can include one or more actuators 250. The actuators 250 can be element or combination of elements operable to alter one or more of the vehicle systems 240 or components thereof to responsive to receiving signals or other inputs from the processor(s) 210 and/or the autonomous driving system 260. For instance, the one or more actuators 250 can include motors, pneumatic actuators, hydraulic pistons, relays, solenoids, and/or piezoelectric actuators, just to name a few possibilities.

The vehicle 200 can include one or more modules, at least some of which are described herein. The modules can be implemented as computer-readable program code that, when executed by a processor(s) 210, implements one or more of the various processes described herein. One or more of the modules can be a component of the processor(s) 210, or one or more of the modules can be executed on and/or distributed among other processing systems to which the processor(s) 210 is operatively connected. The modules can include instructions (e.g., program logic) executable by one or more processor(s) 210. Alternatively, or in addition, one or more data store(s) 215 may contain such instructions.

In one or more arrangements, one or more of the modules described herein can include artificial intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 200 can include an autonomous driving system 260. The autonomous driving system 260 can be configured to receive data from the sensor system 220 and/or any other type of system capable of capturing information relating to the vehicle 200 and/or the external environment of the vehicle 200. In one or more arrangements, the autonomous driving system 260 can use such data to generate one or more driving scene models. The autonomous driving system 260 can determine position and velocity of the vehicle 200. The autonomous driving system 260 can determine the location of obstacles, obstacles, or other environmental features including traffic signs, trees, shrubs, neighboring vehicles, pedestrians, etc.

The autonomous driving system 260 can be configured to receive, and/or determine location information for obstacles within the external environment of the vehicle 200 for use by the processor(s) 210, and/or one or more of the modules described herein to estimate position and orientation of the vehicle 200, vehicle position in global coordinates based on signals from a plurality of satellites, or any other data and/or signals that could be used to determine the current state of the vehicle 200 or determine the position of the vehicle 200 with respect to its environment for use in either creating a map or determining the position of the vehicle 200 in respect to map data.

The autonomous driving system 260 either independently or in combination with the guardian system 270 can be configured to determine travel path(s), current autonomous driving maneuvers for the vehicle 200, future autonomous driving maneuvers and/or modifications to current autonomous driving maneuvers based on data acquired by the sensor system 220, driving scene models, and/or data from any other suitable source such as determinations from the sensor data 340 as implemented by the control module 320. “Driving maneuver” means one or more actions that affect the movement of a vehicle. Examples of driving maneuvers include accelerating, decelerating, braking, turning, moving in a lateral direction of the vehicle 200, changing travel lanes, merging into a travel lane, and/or reversing, just to name a few possibilities. The autonomous driving system 260 can be configured can be configured to implement determined driving maneuvers. The autonomous driving system 260 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving system 260 can be configured to execute various vehicle functions and/or to transmit data to, receive data from, interact with, and/or control the vehicle 200 or one or more systems thereof (e.g., one or more of vehicle systems 240).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory in communication with the processor and having a control module, the control module having instructions that, when executed by the processor, cause the processor to:
process sensor data about surroundings of a first vehicle to identify suspicious activity in the surroundings of the first vehicle, and
responsive to identifying the suspicious activity, control a second vehicle to perform a reactive maneuver.

2. The system of claim 1, wherein the second vehicle is configured to autonomously follow the first vehicle.

3. The system of claim 1, wherein the reactive maneuver is at least one of: maneuvering the second vehicle to restrict a movement of the first vehicle, maneuvering the second vehicle to restrict access to a door of the first vehicle, maneuvering the second vehicle to follow a party performing the suspicious activity, and maneuvering the second vehicle to block a view of the first vehicle to a party in the surroundings of the first vehicle.

4. The system of claim 1, wherein the control module further includes instructions that, when executed by the processor, cause the processor to control the second vehicle to maneuver to a position that is optimal for viewing the first vehicle.

5. The system of claim 1, wherein the suspicious activity is at least one of: property destruction in the surroundings of the first vehicle, unauthorized physical interaction with the first vehicle, and a party wielding a weapon in the surroundings of the first vehicle.

6. The system of claim 1, wherein the control module further includes instructions that, when executed by the processor, cause the processor to control the first vehicle to autonomously follow the second vehicle, and wherein the reactive maneuver includes traversing a path that leads the first vehicle away from the suspicious activity.

7. The system of claim 1, wherein the sensor data is acquired from at least one of: the first vehicle and the second vehicle.

8. The system of claim 1, wherein the control module further includes instructions that, when executed by the processor, cause the processor to responsive to identifying the suspicious activity, request a remote operator to control the first vehicle.

9. A non-transitory computer-readable medium including instructions that, when executed by a processor, cause the processor to:
process sensor data about surroundings of a first vehicle to identify suspicious activity in the surroundings of the first vehicle; and
responsive to identifying the suspicious activity, control a second vehicle to perform a reactive maneuver.

10. The non-transitory computer-readable medium of claim 9, wherein the second vehicle is configured to autonomously follow the first vehicle.

11. The non-transitory computer-readable medium of claim 9, wherein the reactive maneuver is at least one of: maneuvering the second vehicle to restrict a movement of the first vehicle, maneuvering the second vehicle to restrict access to a door of the first vehicle, maneuvering the second vehicle to follow a party performing the suspicious activity, and maneuvering the second vehicle to block a view of the first vehicle to a party in the surroundings of the first vehicle.

12. The non-transitory computer-readable medium of claim 9, further including instructions that, when executed by the processor, cause the processor to control the second vehicle to maneuver to a position that is optimal for viewing the first vehicle.

13. The non-transitory computer-readable medium of claim 9, further including instructions that, when executed by the processor, cause the processor to control the first vehicle to autonomously follow the second vehicle, and wherein the reactive maneuver includes traversing a path that leads the first vehicle away from the suspicious activity.

14. A method, comprising:
processing sensor data about surroundings of a first vehicle to identify suspicious activity in the surroundings of the first vehicle; and
in response to identifying the suspicious activity, controlling a second vehicle to perform a reactive maneuver.

15. The method of claim 14, wherein the second vehicle is configured to autonomously follow the first vehicle.

16. The method of claim 14, wherein the reactive maneuver is at least one of: maneuvering the second vehicle to restrict a movement of the first vehicle, maneuvering the second vehicle to restrict access to a door of the first vehicle, maneuvering the second vehicle to follow a party performing the suspicious activity, and maneuvering the second vehicle to block a view of the first vehicle to a party in the surroundings of the first vehicle.

17. The method of claim 14, further comprising controlling the second vehicle to maneuver to a position that is optimal for viewing the first vehicle.

18. The method of claim 14, wherein the suspicious activity is at least one of: property destruction in the surroundings of the first vehicle, unauthorized physical interaction with the first vehicle, and a party wielding a weapon in the surroundings of the first vehicle.

19. The method of claim 14, further comprising controlling the first vehicle to autonomously follow the second vehicle, and wherein the reactive maneuver includes traversing a path that leads the first vehicle away from the suspicious activity.

20. The method of claim 14, wherein the sensor data is acquired from at least one of: the first vehicle and the second vehicle.
